(19) United States
(12) Patent Application Publication
(10) Pub. No.: US 2018/0013899 A1
(43) Pub. Date: Jan. 11, 2018

(54) INFORMATION PROCESSING DEVICE, IMAGE FORMING SYSTEM, AND NON-TRANSITORY COMPUTER READABLE MEDIUM

(71) Applicant: FUJI XEROX CO., LTD., Tokyo (JP)

(72) Inventor: Hajime FUKASAWA, Kanagawa (JP)

(73) Assignee: FUJI XEROX CO., LTD., Tokyo (JP)

(21) Appl. No.: 15/443,515

(22) Filed: Feb. 27, 2017

(30) Foreign Application Priority Data
Jul. 6, 2016 (JP) 2016-134554

(51) Int. Cl. H04N 1/00; G02B 27/01

(52) U.S. Cl. CPC H04N 1/0049; H04N 1/00251; H04N 1/00344; H04N 1/00469; H04N 1/00488; G02B 27/017; H04N 1/00246; G02B 2027/0138; G02B 2027/0118; G02B 2027/014; G02B 2027/0141; G02B 2027/0178; H04N 2201/0022; H04N 2201/0039; H04N 2201/0082; H04N 2201/0055

(57) ABSTRACT

An information processing device includes an assistance image display and an assistance-image changing unit. The assistance image display causes a display section of a portable terminal provided with the display section and an image capturing section to display an assistance image for assisting with an operation of a target object be operated by an operator. The assistance-image changing unit changes the assistance image displayed on the display section by the assistance image display to a mode for not assisting with the operation of the target object in a case where a captured image result obtained by the image capturing section of the portable terminal satisfies a predetermined condition.

### CROSS-REFERENCE TO RELATED APPLICATIONS

This application is based on and claims priority under 35 USC 119 from Japanese Patent Application No. 2016-134554 filed Jul. 6, 2016.

### BACKGROUND

### Technical Field

The present invention relates to information processing devices, image forming systems, and non-transitory computer readable media.

### SUMMARY

According to an aspect of the invention, there is provided an information processing device including an assistance image display and an assistance-image changing unit. The assistance image display causes a display section of a portable terminal provided with the display section and an image capturing section to display an assistance image for assisting with an operation of a target object be operated by an operator. The assistance-image changing unit changes the assistance image displayed on the display section. by the assistance image display to a mode for not assisting with the operation of the target object in a case where a captured image result obtained by the image capturing section of the portable terminal satisfies a predetermined condition.

### BRIEF DESCRIPTION OF THE DRAWINGS

An exemplary embodiment of the present invention will be described in detail based on the following figures, wherein:

FIG. 1 illustrates an example of the overall configuration of an image forming system according to an exemplary embodiment;

FIG. 2 illustrates the internal structure of an image forming apparatus according to this exemplary embodiment;

FIG. 3 illustrates the internal structure of an inverting device according to this exemplary embodiment;

FIG. 4 schematically illustrates the configuration of a wearable terminal according to this exemplary embodiment;

FIG. 5 is a block diagram illustrating a functional configuration of the image forming system according to this exemplary embodiment;

FIG. 6 is a flowchart illustrating a process performed by a controller of the wearable terminal according to this exemplary embodiment;

FIGS. 7A and 7B illustrate the state of the image forming system in a case where an assistance image is to be displayed;

FIGS. 8A to 8D are diagrams for explaining a non-assistance display mode; and

FIGS. 9A to 9D are diagrams for explaining another non-assistance display mode performed by display sections.

### DETAILED DESCRIPTION

An exemplary embodiment of the present invention will be described below with reference to the appended drawings.

### Configuration of Image Forming System

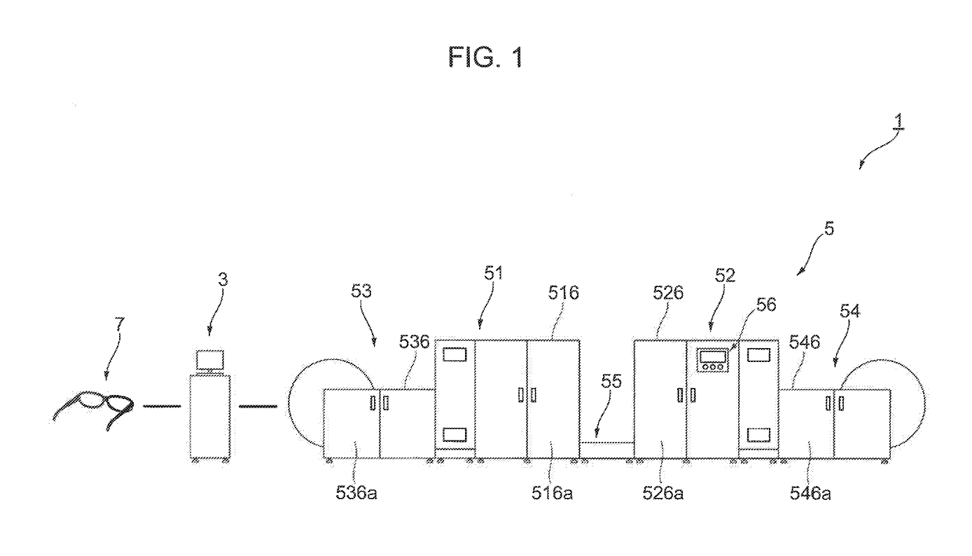

FIG. 1 illustrates an example of the overall configuration of an image forming system 1 according to an exemplary embodiment.

As shown in FIG. 1, the image forming system 1 according to this exemplary embodiment includes a print server 3 that manages, for example, a print job, which is a process based on a print command (i.e., output command), and an image forming apparatus 5 that serves as an example of a target object to be operated by an operator and that executes a printing process (i.e., image forming process) on continuous paper under the control of the print server 3. The image forming system also includes a wearable terminal 7 that is used by being worn by the operator who performs various types of operations on the image forming apparatus 5 and that serves as an example of a portable terminal displaying, for example, an operational assistance image for assisting the operator with the various types of operations.

In the image forming system 1, the print server 3, the image forming apparatus 5, and the wearable terminal 7 are connected to one another in a communicable manner via, for example, a wireless communication line.

### Configuration of Image Forming Apparatus

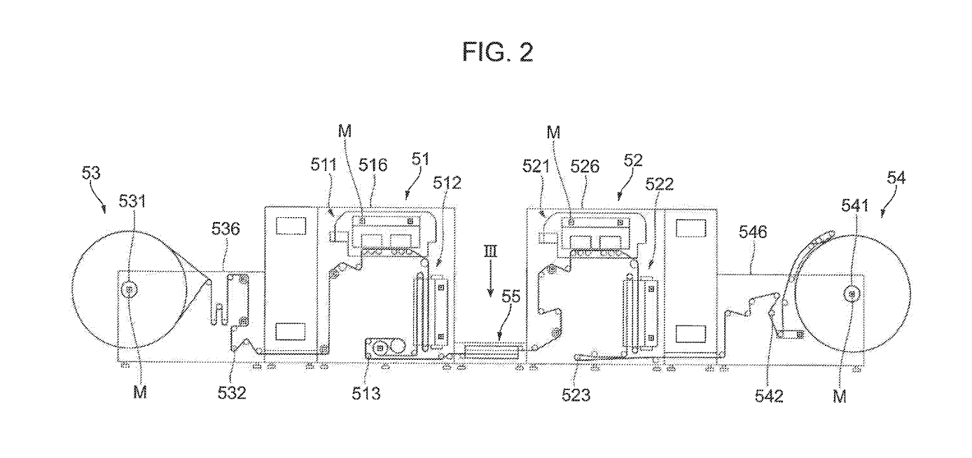

FIG. 2 illustrates the internal structure of the image forming apparatus 5 according to this exemplary embodiment. The image forming apparatus 5 according to this exemplary embodiment forms an image onto transported continuous paper. In the image forming apparatus 5 according to this exemplary embodiment, the continuous paper is transported at a high speed of, for example, about 100 meters per minute so as to allow for high-speed printing of several thousands of pages per minute. The continuous paper in this exemplary embodiment refers to paper that is continuous in the transport direction in the image forming apparatus 5. The continuous paper may be, for example, perforated or folded so long as it is continuous in the transport direction.

As shown in FIGS. 1 and 2, the image forming apparatus 5 is a combination of multiple devices. Specifically, the image forming apparatus 5 includes a first image forming device 51 that forms an image onto one face of the continuous paper and a second image forming device 52 that forms an image onto one face or the other face of the continuous paper on which the image is formed by the first image forming device 51. The image forming apparatus 5 also includes a paper feeding device 53 that feeds the continuous paper to the first image forming device 51 and a collecting device 54 that collects the continuous paper by winding it up after the image is formed thereon by the second image forming device 52. Furthermore, the image forming apparatus 5 includes an inverting device 55 that inverts the front and rear faces of the continuous paper, as appropriate, having the image formed thereon by the first image forming device 51 and transports the continuous paper to the second image forming device 52. Moreover, the image forming apparatus 5 includes multiple relay units (not shown) that relay between the paper feeding device 53 and the first image forming device 51, between the first image forming device 51 and the inverting device 55, between the inverting device 55 and the second image forming device 52, and between the second image forming device 52 and the collecting device 54.

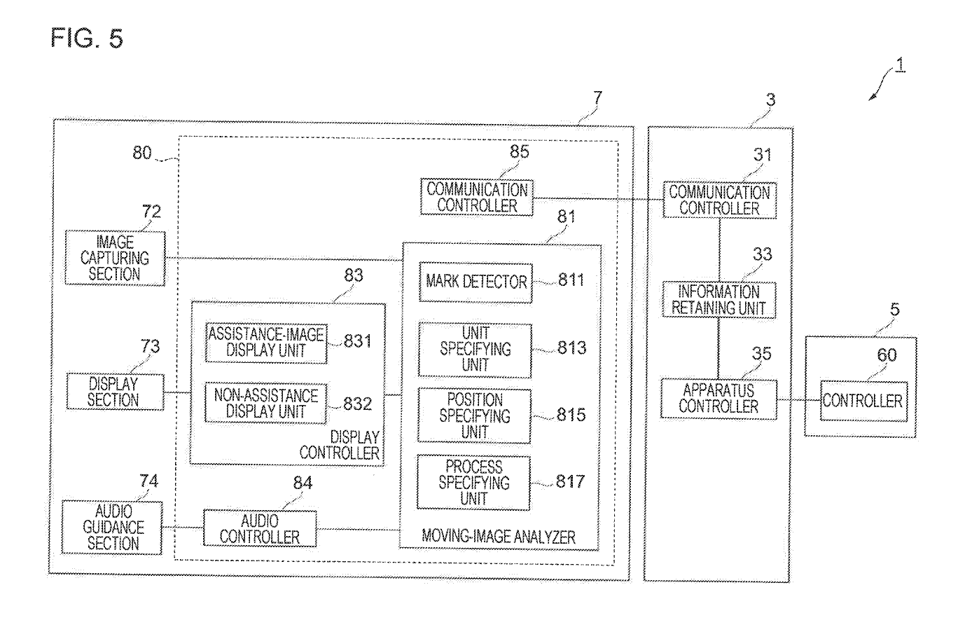

The image forming apparatus includes a display panel 55 (see FIG. 1) that receives an operation input by the operator and displays information to the operator, and also includes a controller 60 (see FIG. 5 to be described later) that controls the operation of each device in the image forming apparatus 5 and that communicates with the print server 3.

As shown in FIGS. 1 and 2, the first image forming device 51 includes a first image forming unit 511 that forms an image onto one face of the transported continuous paper and a first drying unit 512 that dries the continuous paper having the image formed thereon by the first image forming unit 511. Furthermore, the first image forming device 51 includes multiple transport rollers 513 that transport the continuous paper. The first image forming device 51 also includes a housing 516 that accommodates, for example, the first image forming unit 511, the first drying unit 512, and the transport rollers 513. As shown in FIG. 1, the housing 516 has an openable-closable door 516a that may be operated by, for example, the operator when loading continuous paper.

The first image forming unit 511 forms an image onto the continuous paper based on the so-called inkjet method. Specifically, the first image forming unit 511 has an inkjet head (not shown) having multiple nozzles that eject ink therefrom as liquid droplets.

The first drying unit 512 heats the ink ejected on the continuous paper by the first image forming unit 511 so as to dry the ink. Specifically, the first drying unit 512 includes a heater (not shown) that generates heat by being supplied with electricity.

The second image forming device 52 has a configuration similar to that of the first image forming device 51. Specifically, the second image forming device 52 includes a second image forming unit 521 that has an inkjet head and that forms an image onto the continuous paper based on the so-called inkjet method, and also includes a second drying unit 522 that heats ink ejected on the continuous paper by the second image forming unit 521 so as to dry the ink. The second image forming device 52 also includes multiple transport rollers 523 that transport the continuous paper. Furthermore, the second image forming device 52 includes a housing 526 that has an openable-closable door 526a and that accommodates, for example, the second image forming unit 521, the second drying unit 522, and the transport rollers 523.

The paper feeding device 53 feeds the roll-wound continuous paper to the first image forming device 51 via a replay unit while unwinding the continuous paper. The paper feeding device 53 includes a rotatable roller member 531 that supports the roll-wound continuous paper and also includes multiple transport rollers 532 that transport the continuous paper unwound from the roller member 531 toward the first image forming device 51. Furthermore, the paper feeding device 53 includes a housing 536 that has an openable-closable door 536a and that accommodates the roller member 531, the transport rollers 532, and the continuous paper supported by the roller member 531.

The collecting device 54 collects the continuous paper having the image formed thereon by the second image forming device 52 while winding up the continuous paper into the shape of a roll. Specifically, the collecting device 54 includes a rotatable roller member 541 that winds up the continuous paper into the shape of a roll and also includes multiple transport rollers 542 that transport the continuous paper released from the second image forming device 52 toward the roller member 541. Furthermore, the collecting device 54 includes a housing 546 that has an openable-closable door 546a and that accommodates the roller member 541, the transport rollers 542, and the continuous paper supported by the roller member 541.

In the image forming apparatus 5 according to this exemplary embodiment, the paper feeding device 53 feeds the roll-wound continuous paper while unwinding it, and the collecting device 54 collects the continuous paper while winding it up into the shape of a roll. Alternatively, the type of continuous paper is not limited to this. For example, continuous paper accordion-folded along perforations may be fed while being unfolded by the paper feeding device 53, and may be collected while being accordion-folded along the perforations by the collecting device 54.

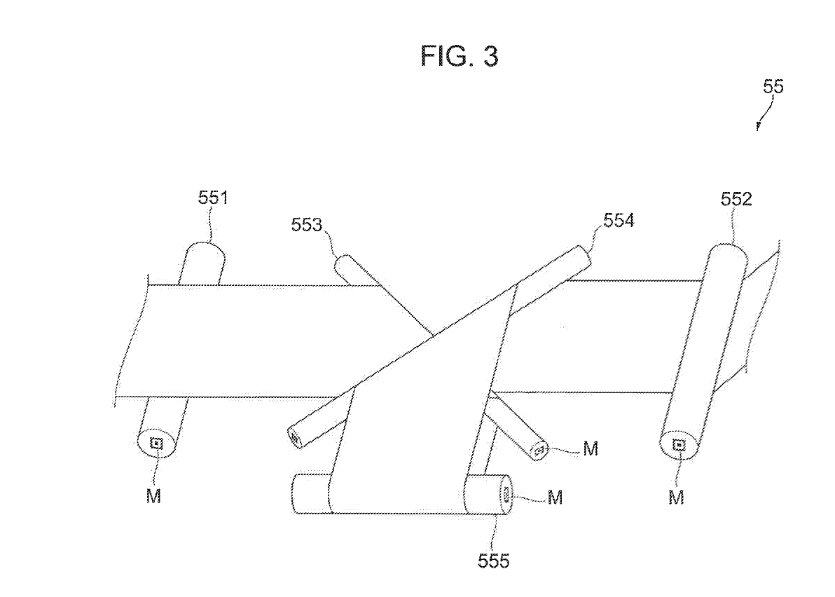

FIG. 3 illustrates the internal structure of the inverting device 55 according to this exemplary embodiment and corresponds to the diagram of the inverting device 55 shown in FIG. 2 as viewed from the direction of arrow III.

The inverting device 55 inverts the front and rear faces of the continuous paper, as appropriate, having an image formed thereon by the first image forming device 51 and transports the continuous paper to the second image forming device 52. In the inverting device 55, the method of loading the continuous paper onto inverting rollers 551 to 555, to be described later, varies between a case where the front and rear faces of the continuous paper are to be inverted and a case where the front and rear faces of the continuous paper are not to be inverted. FIG. 3 illustrates the case where the front and rear faces of the continuous paper are inverted by the inverting device 55.

In the image forming apparatus 5 according to this exemplary embodiment, the first image forming device 51, the second image forming device 52, the paper feeding device 53, the collecting device 54, and the inverting device 55 are each provided with a mark M that is visually recognizable at the wearable terminal 7 by the operator and that is used for specifying a region (unit) of the image forming apparatus 5.

For example, in the first image forming device 51, the first image forming unit 511, the first drying unit 512, and the transport rollers 513 are each provided with a mark M. Likewise, in the second image forming device 52, the second image forming unit 521, the second drying unit 522, and the transport rollers 523 are each provided with a mark M. Moreover, in the inverting device 55, the inverting rollers 551 to 555 are each provided with a mark M.

In the image forming system 1 according to this exemplary embodiment, a unit of the image forming apparatus 5 visually recognized by the operator is specified by detecting and analyzing an image of a mark M captured by an image capturing section 72 of the wearable terminal 7. This will be described in detail later. Units of the image forming apparatus 5 in this exemplary embodiment refer to component units of the image forming apparatus 5 that are differentiated from one another based on the functions and positions thereof. For example, the units of the image forming apparatus 5 correspond to the first image forming unit 511 and the first drying unit 512 of the first image forming device 51, the second image forming unit 521 and the second drying unit 522 of the second image forming device 52, the inverting rollers 551 to 555 of the inverting device 55, the paper feeding device 53, the collecting device 54, and the relay units.

In the image forming apparatus 5 according to this exemplary embodiment, the type of mark M varies from attached unit to attached unit of the image forming apparatus 5 so that each unit is specifiable by detecting and analyzing a mark M, although not specifically shown in the drawings. Specifically, for example, in the image forming apparatus 5, the shape, color, and pattern of mark M varies from attached unit to attached unit.

Furthermore, in the image forming apparatus 5, each mark M is provided inside the housing of the corresponding device. For example, in the first image forming device 51, the mark M attached to each unit is provided inside the housing 516. When the openable-closable door 516a of the housing 516 is opened, the marks M become exposed to the outside so as to become visually recognizable.

Furthermore, although not shown in the drawings, each unit of the image forming apparatus 5 according to this exemplary embodiment has a sensor that detects the status of the unit. In the image forming apparatus 5, for example, the sensor provided in each unit performs output in accordance with an operation, such as loading of continuous paper, in the unit. Then, the controller 60 of the image forming apparatus 5 ascertains the status of the unit by monitoring the output status of the sensor.

### Configuration of Wearable Terminal

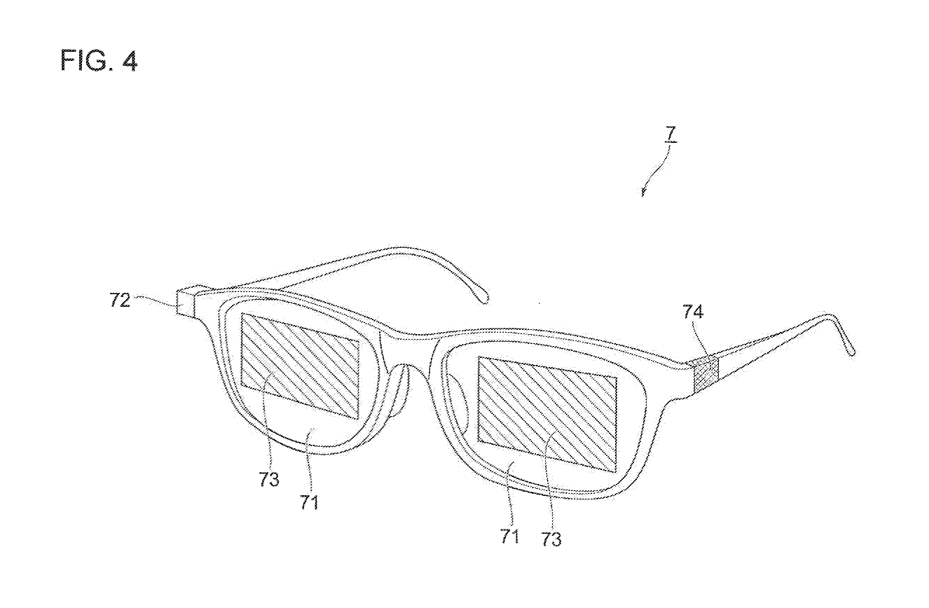

FIG. 4 schematically illustrates the configuration of the wearable terminal 7 according to this exemplary embodiment. As shown in FIG. 4, the wearable terminal 7 according to this exemplary embodiment has the shape of eyeglasses in its entirety and is used by being worn on the head of the operator.

The wearable terminal 7 includes lens sections 71 provided at positions corresponding to the left and right eyes of the operator when worn, the image capturing section 72 that captures an image of a region visually recognized through the lens sections 71 by the operator, and display sections 73 that display an image over the view visually recognized through the lens sections 71 by the operator. The wearable terminal 7 also includes an audio guidance section 74 that provides audio guidance to the operator. The wearable terminal 7 further includes a controller 80 (see FIG. 5 to be described later) that controls each section.

The lens sections 71 are composed of a material having optical transparency. Thus, the operator wearing the wearable terminal 7 may visually recognize the front view through the lens sections 71.

The image capturing section 72 is constituted of a compact camera, such as a charge coupled device (CCD) camera, and is provided adjacent to one of the lens sections 71 so as to be oriented in the direction of the line of vision of the operator wearing the wearable terminal 7. The image capturing section 72 captures a moving image of the view visually recognized through the lens sections 71 by the operator and outputs the captured moving image to the controller 80.

The display sections 73 are formed to overlap the lens sections 71 and are composed of a material having optical transparency when an image is not displayed thereon. Based on display control performed by the controller 80, the display sections 73 display an image over the view (i.e., actual image) visually recognized through the lens sections 71 by the operator.

The audio guidance section 74 has a compact speaker and outputs sound based on control by the controller 80 so as to guide the operator.

### Functional Configuration of Image Forming System

FIG. 5 is a block diagram illustrating a functional configuration of the image forming system 1 according to this exemplary embodiment.

The print server 3 according to this exemplary embodiment includes a communication controller 31 that controls communication with, for example, the wearable terminal 7 and the image forming apparatus 5. For example, the communication controller 31 acquires, from the wearable terminal 7, information related to a unit specified by a unit specifying unit 813 to be described later. Furthermore, the communication controller 31 acquires, from the image forming apparatus 5, information related to apparatus settings set in the image forming apparatus 5. Moreover, the communication controller 31 outputs, to the wearable terminal 7, information related to an assistance image retained in an information retaining unit 33, to be described later, based on the unit-related information acquired from the wearable terminal 7.

The print server 3 includes the information retaining unit 33 that retains the information related to the assistance image for assisting the operator in operating the image forming apparatus 5.

Furthermore, the print server 3 includes an apparatus controller 35 that controls the status of the image forming apparatus 5 and the execution of a job in the image forming apparatus 5.

The controller 80 of the wearable terminal 7 includes a moving-image analyzer 81 as an example of an acquiring unit that analyzes the moving image captured by the image capturing section 72. Furthermore, the controller 80 of the wearable terminal 7 includes a display controller 83 that controls the image displayed on the display sections 73. Moreover, the controller 80 of the wearable terminal 7 also includes an audio controller 84 as an example of an audio notifier that controls sound output by the audio guidance section 74. The controller 80 of the wearable terminal 7 further includes a communication controller 85 that communicates with the print server 3.

The moving-image analyzer 81 includes a mark detector 811 that detects a mark M included in the moving image, which is a captured image result, captured by the image capturing section 72. The moving-image analyzer 81 has the unit specifying unit 813 that specifies a unit of the image forming apparatus 5, which is image-captured by the image capturing section 72, based on the mark M detected by the mark detector 811. The moving-image analyzer 81 also has a position specifying unit 815 that specifies the positional relationship between the unit specified by the unit specifying unit 813 and the wearable terminal 7 based on the mark M detected by the mark detector 811. Moreover, the moving-image analyzer 81 has a process specifying unit 817 that specifies an operational process performed by the operator on the unit specified by the unit specifying unit 813 based on the moving image captured by the image capturing section 72 and information acquired from the print server 3.

The display controller 83 has an assistance-image display unit 831 as an example of an assistance image display that causes the display sections 73 to display an assistance image. The assistance-image display unit 831 causes the display sections 73 to display the assistance image based on, for example, information acquired from the print server 3 via the communication controller 85 and information related to the mark M detected by the moving-image analyzer 81.

Furthermore, the display controller 83 has a non-assistance display unit 832 as an example of an assistance-image changing unit or a blocking image display that changes the display mode on the display sections 73 to a non-operational assistance mode for the operator based on the positional relationship specified by the position specifying unit 815 of the moving-image analyzer 81. The non-assistance display unit 832 displays a blocking image or a warning image, which will be described later, based on the positional relationship specified by the position specifying unit 815 of the moving-image analyzer 81. Furthermore, the non-assistance display unit 832 changes the assistance image displayed by the assistance-image display unit 831 to the non-operational assistance mode.

The communication controller 85 outputs, to the print server 3, for example, information related to the unit of the image forming apparatus 5 specified by the unit specifying unit 813 of the moving-image analyzer 81. Moreover, the communication controller 85 acquires assistance-image-related information output from the print server 3.

In the image forming system 1 according to this exemplary embodiment, since the continuous paper is transported at high speed during the printing process in the image forming apparatus 5, there are many components rotating at high speed within each device constituting the image forming apparatus 5. Moreover, the first drying unit 512 of the first image forming device 51 and the second drying unit 22 of the second image forming device 52 increase in temperature especially during the printing process for forcedly drying the ink by heating.

Because the image forming apparatus 5 according to this exemplary embodiment has a complex structure, highly technical knowledge is necessary for operations, such as maintenance and inspection processes, of the image forming apparatus 5. Therefore, a preliminarily-educated operator normally operates the image forming apparatus 5 while reading, for example, an instruction manual. However, since the image forming apparatus 5 is large in size, various kinds of operations are to be performed while moving around the image forming apparatus 5 instead of operating it at a single location. In this case, when operating the image forming apparatus 5, it may be inconvenient for the operator to refer to a document, such as the instruction manual, while carrying it around.

In contrast, in the image forming system 1 according to this exemplary embodiment, the assistance image for assisting the operator in operating the image forming apparatus 5 is displayed on the display sections 73 of the wearable terminal 7 worn by the operator. Thus, the operator may refer to the assistance image displayed on the display sections 73 of the wearable terminal 7 so that the operational efficiency may be improved, as compared with a case where, for example, the operator refers to a document during the operation.

For example, an operation, such as a maintenance process, of the image forming apparatus 5 according to this exemplary embodiment often involves stretching an arm or putting one side of the body into the housing of each device constituting the image forming apparatus 5 by opening the housing. In this case, if the operation is performed in a state where the assistance image is displayed on the display sections 73 of the wearable terminal 7, the field of view is reduced by the assistance image, possibly hitting the body against the housing or a section existing within the housing.

In addition, the image forming apparatus 5 is usually connected to accessories, such as a power cable, a network cable, an air tube, and a cooling hose, and consumables and relevant devices are often placed in the vicinity thereof. If the operator walks around such a place in the state where the assistance image is displayed on the display sections 73 of the wearable terminal 7, it may be difficult for the operator to focus on such accessories and consumables, possibly causing the operator to come into contact with or trip over them.

### Process Performed in Image Forming System

In contrast, in this exemplary embodiment, the positional relationship between the wearable terminal 7 and each unit of the image forming apparatus 5 is specified, and the display on the display sections 73 of the wearable terminal 7 is changed based on the specified positional relationship. Consequently, reduced ease of operation caused by the image displayed on the display sections 73 of the wearable terminal 7 or by the wearable terminal 7 may be suppressed.

A process performed in the image forming system 1 according to this exemplary embodiment will be described in detail below.

The process performed in the image forming system 1 to be described below is realized as a result of software and hardware resources operating in cooperation with each other. Specifically, central processing units (CPUs) within control computers provided in the wearable terminal 7 and the print server 3 execute programs for realizing the functions of the wearable terminal and the print server 3, so that these functions are realized.

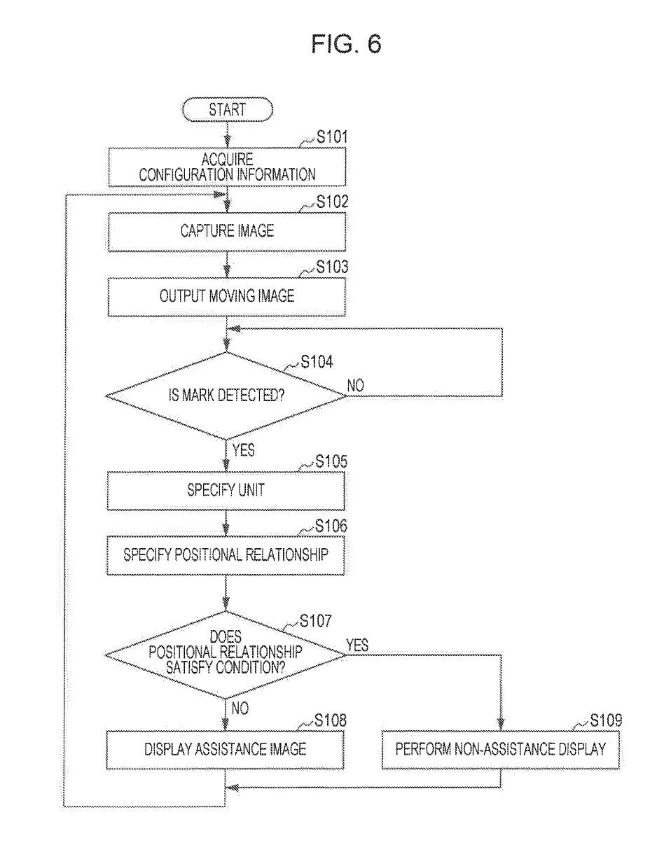

FIG. 6 is a flowchart illustrating a process performed by the controller 80 of the wearable terminal 7 according to this exemplary embodiment.

When the wearable terminal 7 is activated by the operator, the communication controller 85 performs communication so as to acquire information related to the configuration of the image forming apparatus 5 from the print server 3 in step S101. An example of the information related to the configuration of the image forming apparatus 5 includes information (configuration information) related to the configuration of the units included in the image forming apparatus 5.

In step S102, the image capturing section 72 performs an image capturing process. As described above, in the wearable terminal 7 according to this exemplary embodiment, an image of the view visually recognized through the lens sections 71 by the operator wearing the wearable terminal 7 is captured as a moving image by the image capturing section 72.

In step S103, the moving image captured by the image capturing section 72 is output to the moving-image analyzer 81, where the moving image is analyzed.

In step S104, the mark detector 811 in the moving-image analyzer 81 first detects a mark M from the moving image captured by the image capturing section 72. If a mark M is not detectable from the moving image (NO in step S104), the step for detecting a mark M is continuously performed.

If a mark M is detected by the mark detector 811 (YES in step S104), the unit specifying unit 813 specifies a unit of the image forming apparatus 5 included in the moving image captured by the image capturing section 72 based on the detected mark N in step S105. Specifically, the mark M detected by the mark detector 811 is image-analyzed. Then, it is specified whether any of the units of the image forming apparatus 5 is included in the moving image captured by the image capturing section 72 based on the type (e.g., shape, color, and pattern) of the mark N and the information related to the configuration of the image forming apparatus 5 acquired in step S101.

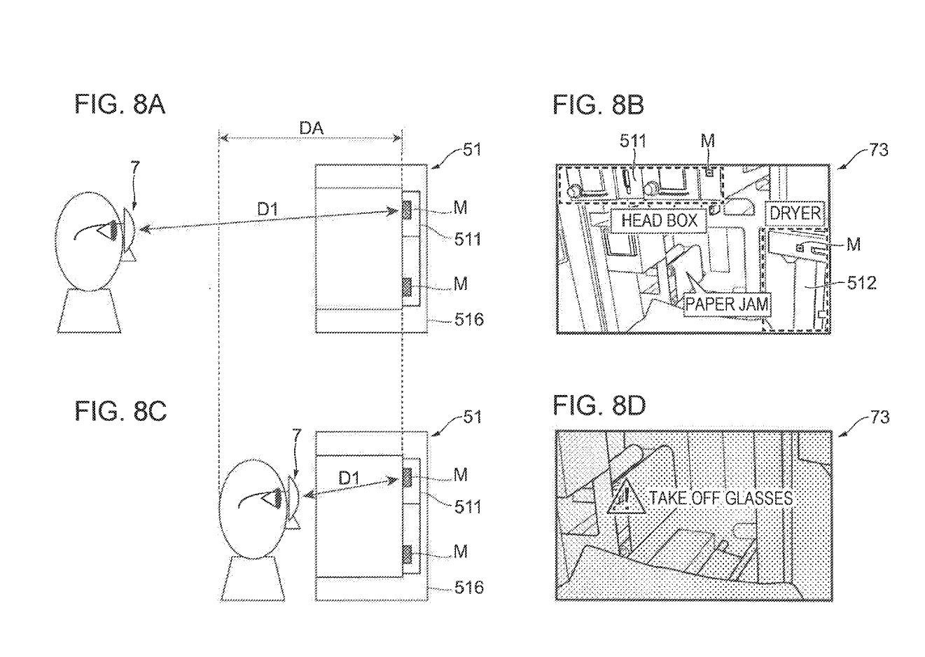

Subsequently, in step S106, the position specifying unit 815 specifies the positional relationship between the unit of the image forming apparatus 5 and the wearable terminal 7 based on the mark N detected in step S104. In this example, the position specifying unit 815 specifies a distance D1 (see FIGS. 8A and 8C) between the unit of the image forming apparatus and the wearable terminal 7 based on, for example, the size of the mark M. Specifically, the larger the distance between the unit of the age forming apparatus 5 and the wearable terminal 7, the smaller the image of the mark M captured by the image capturing section 72, whereas the smaller the distance, the larger the image of the mark M captured by the image capturing section 72. From this relationship, the distance D1 between the unit of the image forming apparatus 5 and the wearable terminal 7 is specified based on the size of the detected mark M.

Then, in step S107, the position specifying unit 815 determines whether or not the positional relationship between the unit specified in step S105 and the wearable terminal 7 satisfies a predetermined condition. An example of the predetermined condition for the positional relationship includes whether or not the distance D1 between the unit and the wearable terminal 7 specified by the position specifying unit 815 is smaller than or equal to a predetermined reference distance DA (see FIGS. 8A and 8C).

If the positional relationship between the unit and the wearable terminal 7 does not satisfy the predetermined condition (NO in step S107), the assistance-image display unit 831 of the display controller 83 causes the display sections 73 to display an assistance image for assisting the operator in operating the image forming apparatus 5 in step S108 based on information acquired from the print server 3. For example, if the distance D1 between the unit of the image forming apparatus 5 and the wearable terminal 7 is larger than the predetermined reference distance DA, it is determined that the predetermined condition is not satisfied, and the assistance image is displayed on the display sections 73. The displaying of the assistance image in step S108 will be described in detail later.

If the positional relationship between the unit and the wearable terminal 7 satisfies the predetermined condition (YES in step S107), the non-assistance display unit 832 of the display controller 83 causes the display sections 73 to change to a display mode for not assisting the operator in operating the image forming apparatus (sometimes referred to as “non-assistance display mode” hereinafter) in step S109. For example, if the distance D1 between the unit of the image forming apparatus 5 and the wearable terminal 7 is smaller than or equal to the predetermined reference distance DA, it is determined that the predetermined condition is satisfied, and the non-assistance display mode is performed at the display sections 73.

The non-assistance display mode performed at the display sections 73 includes displaying a blocking image for blocking the view through the lens sections 71 or displaying a warning image for prompting the operator to take off the wearable terminal 7. If the display sections 73 are already displaying an assistance image, an example of the non-assistance display mode performed at the display sections 73 includes deleting the assistance image from the display sections 73 or changing the display position or the display size of the assistance image. The non-assistance display mode in step S109 will be described in detail later.

After displaying the assistance image in step S108 or performing the non-assistance display mode in step S109, the process returns to step S102 so as to continue with the series of steps.

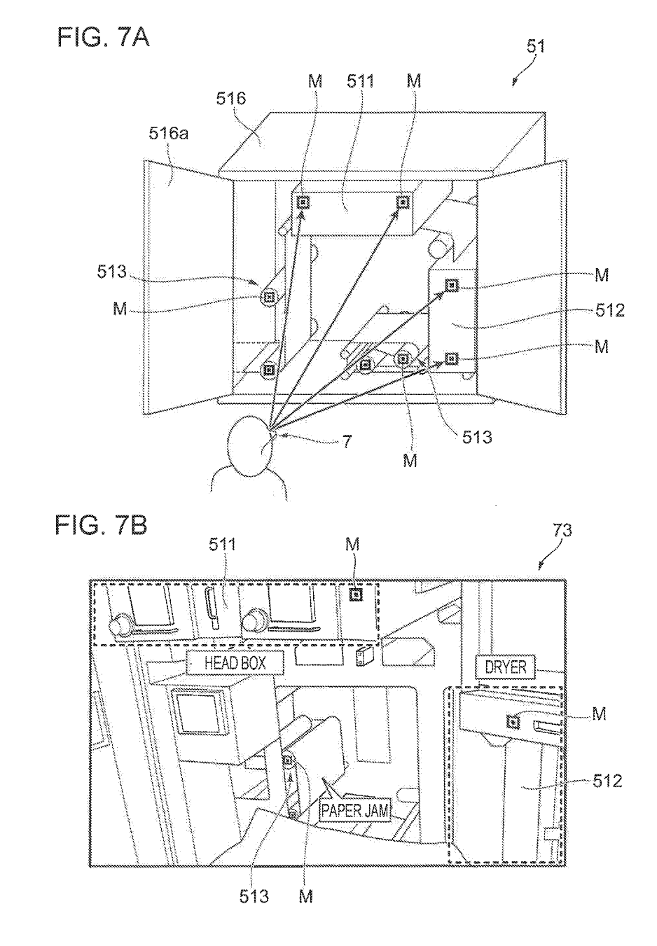

Next, an example of displaying of the assistance image in step S108 will be described in further detail. FIGS. 7A and 7B illustrate the state of the image forming system 1 in a case where the assistance image is to be displayed. Specifically, FIG. 7A illustrates the states of the image forming apparatus 5 and the wearable terminal 7, and FIG. 7B illustrates an example of an image displayed on the display sections 73 of the wearable terminal 7.

In this example, as shown in FIG. 7A, the operator wearing the wearable terminal 7 opens the openable-closable door 516a of the housing 516 so as to visually recognize the interior of the first image forming device 51. Thus, as shown in FIG. 7A, images of the marks M attached to the first image forming unit 511, the first drying unit 512, and the transport rollers 513 in the first image forming device 51 are captured by the image capturing section 72. In this example, in step S105 described above, the first image forming unit 511, the first drying unit 512, and the transport rollers 513 are specified as units of the image forming apparatus 5 based on these marks M.

If it is determined in step S107 described above that the positional relationship between the unit of the image forming apparatus 5 and the wearable terminal 7 does not satisfy the predetermined condition, the information related to the unit of the image forming apparatus 5 specified by the unit specifying unit 813 in step S105 is output to the print server 3 by the communication controller 85.

In the print server 3, the information retaining unit 33 creates information related to an assistance image fox assisting the operator in operating the relevant unit based on the information related to the unit of the image forming apparatus 5 acquired from the wearable terminal 7, and the communication controller 31 outputs the information to the wearable terminal 7.

Then, in the wearable terminal 7, the communication controller 85 acquires the information related to the assistance image output from the print server 3. In this example, information related to an assistance image for assisting the operator in operating the specified first image forming unit 511, first drying unit 512, and transport rollers 513 is acquired. The information related to the assistance image is information necessary for displaying the assistance image on the display sections 73 and includes information related to the name of a component constituting a specified unit or information related to an operational procedure for a specified unit.

Subsequently, based on the information related to the assistance image acquired by the communication controller 85, the assistance-image display unit 831 of the display controller 83 causes the display sections 73 to display the assistance image. Specifically, based on the position of each mark M image-captured by the image capturing section 72, the display sections 73 display the assistance image over the view of each unit visually recognized through the lens sections 71 by the operator.

In this example, as shown in FIG. 7B, the guidance “head box” is displayed as the assistance image over the first image forming unit 511 visually recognized through the lens sections 71 by the operator. Furthermore, the guidance “dryer” is displayed as the assistance image over the first drying unit 512 visually recognized through the lens sections 71 by the operator. Moreover, the guidance “paper jam” is displayed as the assistance image over the continuous paper extended around the transport rollers 513 and visually recognized through the lens sections 71 by the operator.

The operator wearing the wearable terminal 7 may operate the image forming apparatus 5 by referring to the assistance image displayed on the display sections 73. In the example shown in FIG. 7B, it is clear from the assistance image displayed on the display sections 73 that a paper jam has occurred in the continuous paper extended around the transport rollers 513. Thus, the operator wearing the wearable terminal 7 may remove the paper jam by referring to the assistance image on the display sections 73.

Accordingly, in the image forming system 1 according to this exemplary embodiment, the assistance image is displayed on the display sections 73 of the wearable terminal 7 so that the ease of operation of the image forming apparatus by the operator may be improved.

Next, an example of the non-assistance display mode performed in the wearable terminal 7 according to this exemplary embodiment will be described in detail. FIGS. 8A to 8D are diagrams for explaining the non-assistance display mode. In this example, the operator wearing the wearable terminal 7 opens the openable-closable door 516a of the housing 516 so as to visually recognize the interior of the first image forming device 51, as in the example shown in FIGS. 7A and 7B. Then, images of the marks M provided at the first image forming unit 511, the first drying unit 512, and the transport rollers 513 of the first image forming device 51 are captured by the image capturing section 72, and these units are specified by the unit specifying unit 813.

FIGS. 8A and 8C illustrate the positional relationship between the operator wearing the wearable terminal 7 and the first image forming device 51, and FIGS. 8B and 8D illustrate an image displayed on the display sections 73 of the wearable terminal 7 and a view visually cognized through the lens sections 71 by the operator in FIGS. 8A and 8C, respectively.

As described above, in this exemplary embodiment, as the positional relationship between each unit of the image forming apparatus 5 (i.e., the first image forming device 51) and the wearable terminal 7, the distance D1 between the unit of the image forming apparatus 5 and the wearable terminal 7 is calculated based on the detection result of the corresponding mark M.

As shown in FIG. 8A, if the distance D1 is larger than the predetermined reference distance DA, it is determined that the positional relationship between the unit of the image forming apparatus 5 and the wearable terminal 7 does not satisfy the predetermined condition, and an assistance image is displayed on the display sections 73, as shown in FIG. 8B.

If the operator approaches the first image forming device 51 and the distance D1 thus becomes smaller than the predetermined reference distance DA, as shown in FIG. 8C, it is determined that the positional relationship between the unit of the image forming apparatus 5 and the wearable terminal 7 satisfies the predetermined condition. Then, as shown in FIG. 8D, the display controller 83 switches the display mode in the display sections 73 to the display mode (i.e., the non-assistance display mode) for not assisting with the operation performed by the operator.

In this example, as shown in FIG. 8D, the non-assistance display mode involves displaying a blocking image entirely on the display sections 73 for blocking the view through the lens sections 71 and also displaying a warning image in a superposed manner over the blocking image so as to prompt the operator to take off the wearable terminal 7.

Specifically, as shown in FIG. 8D, a nontransparent pattern or a semitransparent pattern with low optical transparency is displayed entirely on the display sections 73 as the blocking image. Furthermore, as shown in FIG. 8D, a warning message constituted of, for example, the text “take off glasses” and prompting the operator to take off the wearable terminal 7 is displayed as the warning image.

As described above, if the operator is wearing the wearable terminal 7 when operating each unit in the image forming apparatus 5, the field of view of the operator may be reduced by the wearable terminal 7 or by the assistance image displayed on the display sections 73 of the wearable terminal 7. Therefore, if the operator excessively approaches each unit of the image forming apparatus 5, there is a possibility that the operator may hit his/her body against a component constituting the image forming apparatus 5 or touch a heater at high temperature.

In contrast, in this exemplary embodiment, if the distance D1 between each unit of the image forming apparatus 5 and the wearable terminal 7 becomes smaller than or equal to the predetermined reference distance DA, the blocking image and the warning image are displayed on the display sections 73, so as to make it difficult for the operator to continue with the operation while wearing the wearable terminal 7. Thus, the operator may take off the wearable terminal 7 and perform the operation, thereby preventing the field of view of the operator from being reduced by the wearable terminal 7. As a result, this may reduce the possibility of the operator hitting his/her body against a component constituting the image forming apparatus 5 or touching a heater at high temperature.

Furthermore, when the operator is finished with operating each unit of the image forming apparatus 5 and the distance D1 between the unit and the wearable terminal 7 becomes larger than the reference distance due to the operator moving away from the unit, the assistance image is displayed on the display sections 73 again. Thus, the operator may check whether the operation of the unit has properly performed by wearing the wearable terminal 7 again and referring to the assistance image displayed on the display sections 73.

Although the blocking image and the warning image are displayed in a superpose manner on the display sections 73 as the non-assistance display mode for prompting the operator to take off the wearable terminal 7 in this exemplary embodiment, only one of the two images may be displayed on the display sections 73.

Furthermore, in addition to or as an alternative to the warning image displayed on the display sections 73 shown in FIG. 8D, audio guidance for prompting the operator to take off the wearable terminal 7 may be performed by the audio guidance section 74 (see FIG. 4) based on control by the audio controller 84. Specifically, based on control by the audio controller 84, the audio guidance section 74 performs audio guidance by outputting, for example, the audio message “take off glasses”. This makes it possible to prompt the operator to take off the wearable terminal 7, as compared with, for example, a case where the display alone is performed at the display sections 73.

Next, another non-assistance display mode performed at the display sections 73 of the wearable terminal 7 will be described. In the above description with reference to FIGS. 8A to 8D, the non-assistance display mode involves displaying the blocking image and the warning image on the display sections 73 to prompt the operator to take off the wearable terminal 7 so that the field of view is prevented from being blocked by the wearable terminal 7. However, the non-assistance display mode for preventing the field of view from being blocked by the wearable terminal 7 and by the image displayed on the display sections 73 of the wearable terminal 7 is not limited to this.

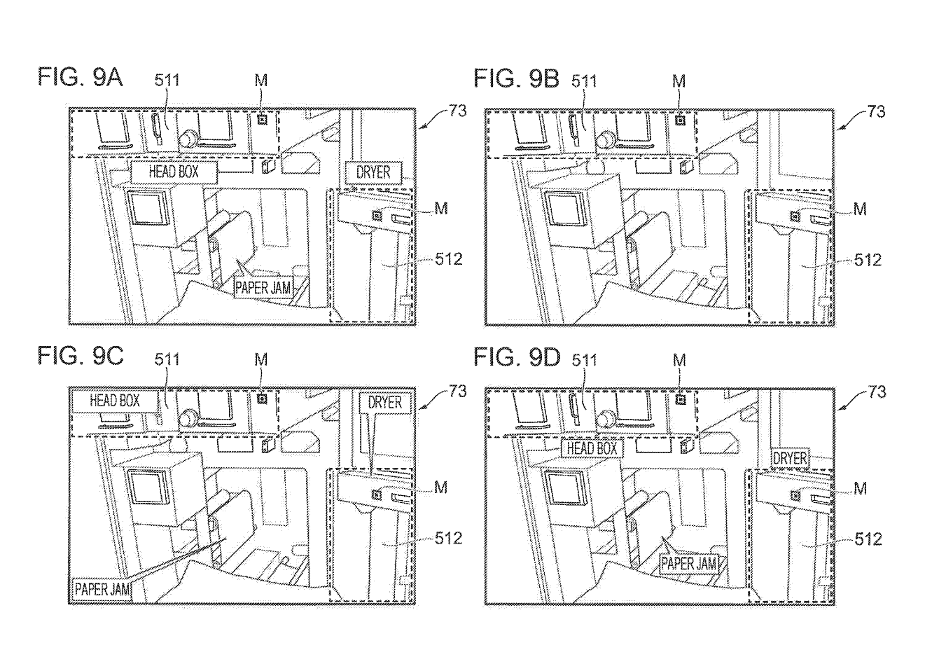

FIGS. 9A to 9D are diagrams for explaining another non-assistance display mode performed at the display sections 73 and illustrate an image displayed on the display sections 73 and a view visually recognized through the lens sections 71 by the operator. Specifically, FIG. 9A illustrates a case where an assistance image is displayed on the display sections 73, and FIGS. 9B to 9D illustrate a case where the non-assistance display mode is performed at the display sections 73.

In the example shown in FIG. 9B, the non-assistance display mode involves deleting the assistance image displayed on the display sections 73 in a case where the positional relationship between each unit of the image forming apparatus 9 and the wearable terminal 7 satisfies the predetermined condition.

In the example shown in FIG. 9C, the non-assistance display mode involves changing the position of the assistance image displayed on the display sections 73. Specifically, the text “head box”, the text “dryer”, and the text “paper jam” constituting the assistance image are moved toward the outer periphery of the display sections 73, as compared with the case shown in FIG. 9A.

Furthermore, in the example shown in FIG. 9D, the non-assistance display mode involves changing the size of the assistance image displayed on the display sections 73. Specifically, the text “head box”, the text “dryer”, and the text “paper jam” constituting the assistance image are reduced in size, as compared with the case shown in FIG. 9A.

In the examples shown in FIGS. 9B to 9D, the non-assistance display mode involves deleting the displayed assistance image or changing the display method for the assistance image, so that the field of view of the operator is prevented from being reduced by the image displayed on the display sections 73, as compared with the case shown in FIG. 9A. In other words, in the example shown in FIGS. 9B to 9D, the visibility of the view through the lens sections 71 is improved for the operator, as compared with a case where the assistance image is continuously displayed on the display sections 73. Consequently, this may reduce the possibility of the operator hitting his/her body against a component constituting the image forming apparatus 5 or touching a heater at high temperature even if the operator continues to wear the wearable terminal 7.

Next, another example of the condition for determining the positional relationship between each unit of the image forming apparatus 5 and the wearable terminal 7 will be described. In the above description, the non-assistance display mode is performed at the display sections 73 in a case where the distance D1 between each unit of the image forming apparatus 5 and the wearable terminal 7 is smaller than or equal to the predetermined reference distance DA.

Alternatively, if the distance D1 between each unit of the image forming apparatus 5 and the wearable terminal 7 is larger than or equal to the predetermined reference distance DA, it may be determined that the positional relationship between the unit of the image forming apparatus 5 and the wearable terminal 7 does not satisfy the condition, and the non-assistance display mode described above may be performed.

Specifically, if the operator is excessively away from the image forming apparatus 5, it is difficult to perform an operation, such as a maintenance process, of the image forming apparatus 5, meaning that there is low necessity for displaying the assistance image on the display sections 73 of the wearable terminal 7. If the field of view of the operator is blocked by the wearable terminal 7 in the case where the operator is excessively away from the image forming apparatus 5, for example, there is a possibility that the operator may come into contact with or trip over consumables and relevant devices placed in the vicinity of the image forming apparatus 5.

In contrast, the non-assistance display mode is performed in a case where the distance D1 between each unit of the image forming apparatus 5 and the wearable terminal is larger than or equal to another reference distance DE so that the field of view of the operator is prevented from being reduced by the wearable terminal 7 when the operator is excessively away from the image forming apparatus 5. As a result, the operator is prevented from walking around the image forming apparatus in a state where the field of view of the operator is blocked by the wearable terminal 7, thereby preventing the operator from coming into contact with or tripping over, for example, consumables and relevant devices placed in the vicinity of the image forming apparatus 5.

In this exemplary embodiment, the non-assistance display mode may be performed at the display sections 73 of the wearable terminal 7 in both the case where the distance D1 between each unit of the image forming apparatus 5 and the wearable terminal 7 is smaller than or equal to the reference distance DA the case where the distance D1 is larger than or equal to the other reference distance DB.

In the above description, in a case where it is not possible for the mark detector 811 to detect a mark M, the detection of a mark M is continuously performed until a mark M is detected. Alternatively, since a mark M is provided inside the housing of each device of the image forming apparatus 5, for example, if the housing of each device is not open, an image of a mark M is not captured by the image capturing section and it is not possible to detect a mark M. Although it is normally necessary to open a housing when operating each unit of the image forming apparatus 5, if the housing is not open and a mark M is thus not detected, it is not possible to operate each unit. Therefore, there is low necessity for displaying the assistance image on the display sections 73 of the wearable terminal 7.

Therefore, in the case where it is not possible for the mark detector 811 to detect a mark M, it may be determined that the positional relationship between each unit of the image forming apparatus 5 and the wearable terminal 7 does not satisfy the predetermined condition, and the aforementioned non-assistance display mode may be performed.

Furthermore, in the above description, the non-assistance display mode is performed at the display sections 73 of the wearable terminal 7 based on the positional relationship between each unit of the image forming apparatus 5 and the wearable terminal 7. However, the condition for performing the non-assistance display mode is not limited to the positional relationship between each unit of the image forming apparatus 5 and the wearable terminal 7. For example, the non-assistance display mode may be performed based on an operational process at a unit specified by the process specifying unit 817 of the moving-image analyzer 81 in accordance with the moving image captured by the image capturing section 72 of the wearable terminal 7.

Specifically, in each device and unit constituting the image forming apparatus 5, the status thereof changes in accordance with an operation performed by the operator, Moreover, in each device and unit constituting the image forming apparatus 5, there are operations where the operator may Nave to open the housing of the device and stretch his/her arm or put one side of the body into the housing, and there are also operations where the operator does not have to excessively approach the interior of the device depending on the type of operation.

Therefore, in the image forming system 1 according to this exemplary embodiment, the process specifying unit 817 specifies an operational process to be performed at each unit, and if that operational process is a predetermined operational process in which the operator has to excessively approach the unit, the aforementioned non-assistance display mode may be performed.

Consequently, this may reduce the possibility of the operator hitting his/her body against a component constituting the image forming apparatus 5 or touching a heater at high temperature.

The method used by the process specifying unit 817 for specifying an operational process at each unit of the image forming apparatus 5 is not limited in particular. For example, the operational process at each unit may be specified by analyzing the moving image captured by the image capturing section 72, detecting the statuses of the continuous paper and the roller member in the unit, and comparing the statuses with information acquired from the print server 3.

Furthermore, for example, as the operator sequentially performs a predetermined series of operational steps, as in a “paper-jam removal process”, the output status of the sensor provided in each unit of the image forming apparatus 5 operated by the operator also changes. Therefore, the operational process at each unit of the image forming apparatus 5 is specified also by monitoring the output status of such a sensor. In other words, an operational process is specifiable not based on a mark M image-captured by the image capturing section 72. Since the process specifying unit 817 specifying an operational process based on such a method receives an output from the sensor in each unit of the image forming apparatus 5, the process specifying unit 817 may be provided in the print server 3 or in the controller 60 of the image forming apparatus 5. In such a case, the wearable terminal 7 may receive the operational process specified by the process specifying unit 817 via the communication controller 85.

Furthermore, in the wearable terminal 7 according to this exemplary embodiment, the display sections 73 display images, such as the assistance image, the blocking image, and the warning image, in a superposed manner over the view visually recognized through the lens sections 71 by the operator wearing the wearable terminal 7. Alternatively, for example, an image (actual image) of the view captured by the image capturing section 72 may be displayed on the display sections 73, and the aforementioned assistance image, blocking image, and warning image may be displayed in a superposed manner over the actual image displayed on the display sections 73.

Furthermore, the wearable terminal 7 according to this exemplary embodiment detects a mark M image-captured by the image capturing section 72 and specifies a unit of the image forming apparatus 5 and the positional relationship between the unit of the image forming apparatus 5 and the wearable terminal 7 based on the detected mark M. However, a mark M does not necessarily have to be used. Specifically, for example, each unit of the image forming apparatus 5 as well as the positional relationship between the unit of the image forming apparatus 5 and the wearable terminal 7 may be specified by analyzing the position and size of each component and the continuous paper using the moving image of the unit of the image forming apparatus 5 captured by the image capturing section 72.

Furthermore, although the process for analyzing the moving image captured by the image capturing section 72 is performed by the controller 80 of the wearable terminal 7 in this exemplary embodiment, some or all of the processes performed by the controller 80 may be performed in the print server 3. In other words, in this exemplary embodiment, the controller 80 of the wearable terminal 7 may constitute an information processing device, the print server 3 may constitute an information processing device, or both the controller 80 of the wearable terminal 7 and the print server 3 may constitute an information processing device.

Furthermore, in this exemplary embodiment, the wearable terminal 7 worn and used by the operator is described as an example of a portable terminal displaying, for example, an assistance image. Alternatively, the portable terminal may be, for example, a smartphone, a portable telephone, a tablet terminal, or a digital camera in place of the wearable terminal 7 so long as the portable terminal is, for example, a medium that is equipped with the display sections 73 displaying an image and the image capturing section 72 capturing a moving image and that is worn by the operator for operating the image forming apparatus 5.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing device comprising:
an assistance image display that causes a display section of a portable terminal provided with the display section and an image capturing section to display an assistance image for assisting with an operation of a target object be operated by an operator; and
an assistance image changing unit that changes the assistance image displayed on the display section by the assistance image display to a mode for not assisting with the operation of the target object in a case where a captured image result obtained by the image capturing section of the portable terminal satisfies a predetermined condition.

2. The information processing device according to claim 1,
wherein the assistance-image changing unit changes the assistance image to the mode for not assisting with the operation of the target object in a case where a positional relationship between the operator and the target object satisfies the predetermined condition based on the captured image result.

3. The information processing device according to claim 1,
wherein the assistance-image changing unit stops displaying the assistance image in a case where the captured image result satisfies the predetermined condition.

4. The information processing device according to claim 1,
wherein the assistance-image changing unit changes a display position or a display size of the assistance image in a case where the captured image result satisfies the predetermined condition.

5. The information processing device according to claim 1,
wherein the assistance-image changing unit changes the assistance image to a blocking image that blocks visibility of the operator through the di section in a case where the captured image result satisfies the predetermined condition.

6. An information processing device comprising:
an acquiring unit that acquires a captured image result of a target object to be operated, the captured image result being obtained by an image capturing section of a portable terminal provided with a display section and the image capturing section; and
a blocking image display that causes the display section of the portable terminal to display a blocking image that blocks visibility of an operator in a case where a positional relationship between the target object and the portable terminal satisfies a predetermined condition based on the captured image result.

7. The information processing device according to claim 6,
wherein the blocking image displayed by the blocking image display includes a nontransparent or semitransparent pattern that covers a view visually recognized through the display section of the portable terminal.

8. The information processing device according to claim 6,
wherein the blocking image display displays a warning image in a superposed manner over the blocking image, the warning image prompting the operator to stop viewing the target object through the display section of the portable terminal.

9. The information processing device according to claim 6, further comprising:
an audio notifier that provides audio notification of information prompting the operator to stop viewing the target object through the display section of the portable terminal.

10. An image forming system comprising:
an image forming apparatus that forms an image onto a recording medium; and
an information processing device having an assistance image display and an assistance-image changing unit, the assistance image display causing a display section of a portable terminal provided with the display section and an image capturing section to display an assistance image for assisting an operator in operating the image forming apparatus, the assistance-image changing unit changing the assistance image displayed on the display section by the assistance image display to a mode for not assisting with the operation of the image forming apparatus in a case where a captured image result obtained by the image capturing section of the portable terminal satisfies a predetermined condition.

11. An image forming system comprising:
an image forming apparatus that forms an image onto a recording medium; and
an information processing device having an acquiring unit and a blocking image display, the acquiring unit acquiring a captured image result of the image forming apparatus, the captured image result being obtained by an image capturing section of a portable terminal provided with a display section and the image capturing section, the blocking image display causing the display section of the portable terminal to display a blocking image that blocks visibility of an operator in a case where a positional relationship between the image forming apparatus and the portable terminal satisfies a predetermined condition based on the captured image result.

12. A non-transitory computer readable medium storing a program causing a computer to execute a process for processing information, the process comprising:
causing a display section of a portable terminal provided with the display section and an image capturing section to display an assistance image for assisting with an operation of a target object be operated by an operator; and
changing the assistance image displayed on the display section to a mode for not assisting with the operation of the target object in a case where a captured image result obtained by the image capturing section of the portable terminal satisfies a predetermined condition.

11. A non-transitory computer readable medium storing a program causing a computer to execute a process for processing information, the process comprising:
acquiring a captured image result of a target object to be operated, the captured image result being obtained by an image capturing section of a portable terminal provided with a display section and the image capturing section; and
causing the display section of the portable terminal to display a blocking image that blocks visibility of an operator in a case where a positional relationship between the target object and the portable terminal satisfies a predetermined condition based on the captured image result.
